(19) United States
(12) Patent Application Publication
(10) Pub. No.: US 2006/0095322 A1
(43) Pub. Date: May 4, 2006

(54) Determining prospective advertising hosts using data such as crawled documents and document access statistics

(76) Inventor: Timothy Matthew Dierks, New York, NY (US)

Correspondence Address: STRAUB & POKOTYLO, 620 TINTON AVENUE, BLDG. B, 2ND FLOOR, TINTON FALLS, NJ, 07724, US

(21) Appl. No.: 10/980,398

(22) Filed: Nov. 3, 2004

(51) Int. Cl. G06Q 30/00

(52) U.S. Cl. 705/14

(57) ABSTRACT

Ad delivery systems want to find good advertising partners easily and efficiently. To this end, available data such as crawled Webpages, access statistics, advertising offers, etc. may be analyzed. The available Webpages may be scored and sorted based on estimated revenue of the Webpages. The scored and sorted Webpges may then be filtered to remove documents considered to be poor prospects and/or documents having characteristics that are considered to make the documents poor prospects, and then presented to the ad delivery system for further use.

§ 1. BACKGROUND OF THE INVENTION

§ 1.1 Field of the Invention

The present invention concerns advertising. In particular, the present invention helps advertisement delivery systems to identify Web-pages which represent good prospects for being advertising hosts.

§ 1.2 Related Art

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.) Query keyword-relevant advertising has been used by search engines. The AdWords advertising system by Google of Mountain View, Calif. is one example of query keyword-relevant advertising. Similarly, content-relevant advertising systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content-relevant advertising, such as the AdSense advertising system by Google, has been used to serve ads on Web pages.

Targeted advertising systems such as AdSense have become so popular that more available ad spots on Webpages are needed to meet expected continued increases in demand by advertisers. Therefore, there is a need for good Webpages for use as advertising hosts. Both the advertisers and ad delivery systems want to place their ads on Websites and Webpages with rich content that get a lot of traffic. Finding such Websites and Webpages is challenging. For example, ad delivery systems may have employees that spend a great deal of time searching and browsing the World Wide Web (“the Web”) for Websites and Webpages rich in content, with a lot of traffic, that are good prospective advertising hosts. It would be useful to provide tools to help ad delivery systems discover such Websites and Webpages.

### § 2. SUMMARY OF THE INVENTION

A method consistent with the present invention may be used to accept documents (e.g., Webpages), score the Webpages (e.g., in terms of expected page views, expected ad revenue per page view, and/or a product of expected page views and expected ad revenue per page view), and sort the scored documents using the scores.

In at least one embodiment consistent with the present invention, candidate documents are filtered to remove documents that are not likely to be good prospective advertising partners.

In at least one embodiment consistent with the present invention, the act of filtering may include removing documents belonging to a predetermined set of documents, such as removing Webpages belonging to a predetermined set of Webpages (e.g., a Website). For example, the act of filtering may remove government Webpages, or documents known to have a policy of excluding advertisements.

### § 3. BRIEF DESCRIPTION OF THE DRAWINGS

FIG. 1 is a diagram showing parties or entities that can interact with an advertising system.

FIG. 2 is a diagram illustrating an environment in which, or with which, the present invention may operate.

FIG. 3 is a bubble chart of exemplary operations that may be performed in a manner consistent with the present invention, as well as information that may be used and/or generated by such operations.

FIG. 4 is a flow diagram of an exemplary method that may be used to discover prospective Websites or Webpages in a manner consistent with the present invention.

FIG. 5 is a block diagram of apparatus that may be used to perform at least some operations and store at least some information consistent with the present invention.

FIG. 6 is a block diagram illustrating an example of operations in an exemplary embodiment consistent with the present invention.

### § 4. DETAILED DESCRIPTION

The present invention may involve novel methods, apparatus, message formats, and/or data structures for helping to find good prospective Websites and/or Webpages for use as advertisement hosts. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventor regards his invention as any patentable subject matter described.

In the following, definitions that may be used in this specification are provided in § 4.1. Then, environments in which, or with which, the present invention may operate are described in § 4.2. Then, exemplary embodiments of the present invention are described in § 4.3. Examples of operations are provided in § 4.4. Finally, some conclusions regarding the present invention are set forth in § 4.5.

§ 4.1 Definitions

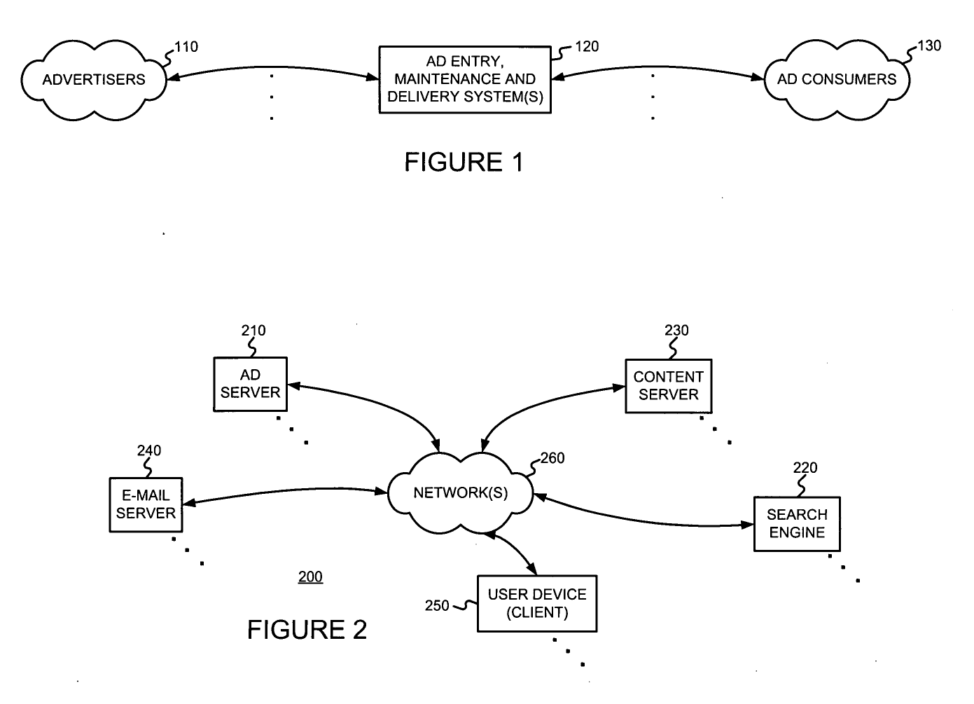

Online ads, such as those used in the exemplary systems described below with reference to FIGS. 1, 2, and 3 or any other system, may have various features. Such features may be specified by an application and/or an advertiser. These features are referred to as “ad features” below. For example, in the case of a text ad, ad features may include a title line, ad text, executable code, an embedded link, etc. In the case of an image ad, ad features may additionally include images, etc. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a page on which the ad is served (including one or more topics or concepts determined to be associated with the page, information or content located on or within the page, information about the page such as the host of the page (e.g. AOL, Yahoo, etc.), the importance of the page as measured by e.g. traffic, freshness, quantity and quality of links to or from the page etc., the location of the page within a directory structure, etc.), a search query or search results associated with the serving of the ad, a user characteristic (e.g., their geographic location, the language they use, the type of browser used, previous page views, previous behavior), a host or affiliate site (e.g., America Online, Google, Yahoo) that initiated the request that the ad is served in response to, an absolute position of the ad on the page on which it is served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as conditions or constraints. When used as serving conditions or constraints, such serving parameters are referred to simply as “serving constraints”. For example, in some systems, an advertiser may be able to specify that its ad is only to be served on weekdays, no lower than a certain position, only to users in a certain location, etc. As another example, in some systems, an advertiser may specify that its ad is to be served only if a page or search query includes certain keywords or phrases.

“Ad information” may include any combination of ad features, ad serving constraints, information derivable from ad features or ad serving constraints (referred to as “ad derived information”), and/or information related to the ad (referred to as “ad related information”), as well as an extensions of such information (e.g., information derived from ad related information).

A “document” is to be broadly interpreted to include any machine-readable and machine-storable work product. A document may be a file, a combination of files, one or more files with embedded links to other files, etc.; the files may be of any type, such as text, audio, image, video, etc. Parts of a document to be rendered to an end user can be thought of as “content” of the document. Ad spots in the document may be defined by embedded information or instructions. In the context of the Internet, a common document is a Web page. Web pages often include content and may include embedded information (such as meta information, hyperlinks, etc.) and/or embedded instructions (such as Javascript, etc.). In many cases, a document has a unique, addressable, storage location and can therefore be uniquely identified by this addressable location. A universal resource locator (URL) is a unique address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer or Netscape), a media player (e.g., an MP3 player, a Realnetworks streaming audio file player, etc.), a viewer (e.g., an Abobe Acrobat pdf reader), etc.

§ 4.2 Environments in which, or with which, the Present Invention may Operate

§ 4.2.1 Exemplary Advertising Environment

FIG. 1 is a high level diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or click-through related to the ad occurred) to the system 120. This usage information may include measured or observed user behavior related to ads that have been served.

The ad server 120 may be similar to the one described in FIG. 2 of U.S. patent application Ser. No. 10/375,900 (incorporated herein by reference), entitled “SERVING ADVERTISEMENTS BASED ON CONTENT,” filed on Feb. 26, 2003 and listing Darrell Anderson, Paul Bucheit, Alex Carobus, Claire Cui, Jeffrey A. Dean, Georges R. Harik, Deepak Jindal, and Narayanan Shivakumar as inventors. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, geolocation information, user profile information, etc.), and price information (e.g., maximum cost (cost per click-though, cost per conversion, etc.)). Alternatively, or in addition, each ad group may include an average cost (e.g., average cost per click-through, average cost per conversion, etc.). Therefore, a single maximum cost and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, etc.), an e-mail facility (e.g., Outlook from Microsoft), etc. A search engine 220 may permit user devices 250 to search collections of documents (e.g., Web pages). A content server 210 may permit user devices 250 to access documents. An e-mail server (such as Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in U.S. patent application Ser. No. 10/375,900 (introduced above), ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, click-through or not, impression time, impression date, size, conversion or not, etc.) back to the ad server 120/210. Alternatively, or in addition, such information may be provided back to the ad server 120/210 by some other means.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate, and/or as described below, information related to, and/or derived from, the search query), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

The search engine 220 may transmit information about the ad and when, where, and/or how the ad was to be rendered (e.g., position, click-through or not, impression time, impression date, size, conversion or not, etc.) back to the ad server 120/210. As described below, such information may include information for determining on what basis the ad way determined relevant (e.g., strict or relaxed match, or exact, phrase, or broad match, etc.) Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under, over, or otherwise in association with an e-mail.

Although the foregoing examples described servers as (i) requesting ads, and (ii) combining them with content, one or both of these operations may be performed by a client device (such as an end user computer for example).

§ 4.3 Exemplary Embodiments

§ 4.3.1 Exemplary Methods

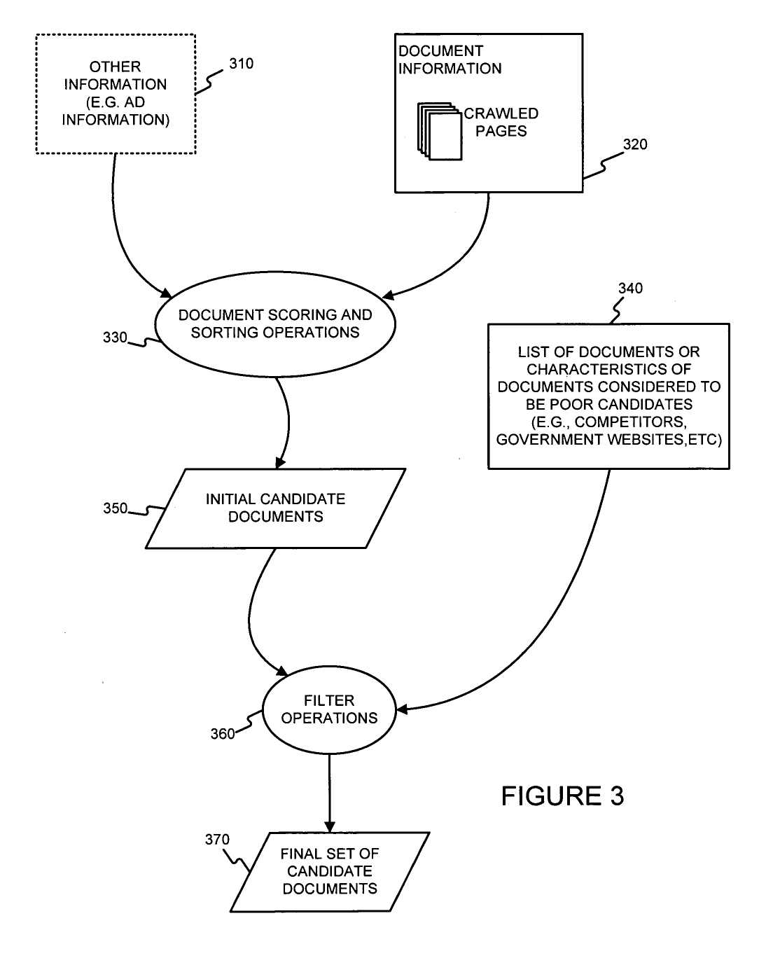

FIG. 3 is a bubble chart of exemplary operations that may be performed in a manner consistent with the present invention, as well as information that may be generated and/or used by such operations. Collectively, such operations may score, sort, and filter document information to produce candidate Webpages and/or Websites as prospective partners for an ad delivery system.

The system may include document scoring and sorting operations 330, as well as filtering operations 360. The document scoring and sorting operations 330 obtain document information 320 and perhaps other information (e.g., ad information) 310 to produce initial candidate documents 350. The filtering operations 360 use the initial candidate documents 350, as well as documents considered to be poor candidates 340 to generate a final set of candidate documents 370.

The document information 320 may contain a variety of information such as crawled Webpages, access statistics, etc. Other information 310 may include ad information, such as offers, categories/topics/classifications, etc.

The document scoring and sorting operations 330 may be used to estimate, for each crawled Webpage obtained from the document information 320, how many page views the Webpage is likely to have (for some time period). Similarly, page views for a group of multiple Webpages can be estimated. Furthermore, the document scoring and sorting operations 330 may estimate the economic value of placing ads on the documents or groups of documents. The resulting economic values can be weighted by the estimated number of page views. The list can be sorted using the weighted economic value for example. As a result, a list of initial candidate documents is produced 350 by the document scoring and sorting operations 330.

List 340 may contain documents or characteristics of documents considered to be pour candidates. For instance, competitor Websites and government Websites will typically not place any ads on their Webpages.

Filter operations 360 use the list of the initial candidate documents 350, along with the list of documents considered to be poor candidates 340, to generate a final set of candidate documents 370. The filtering operations 360 may also use other factors such as, Webpages that already contain advertising or advertising by the same ad delivery system, Webpages that are not compliant with the advertising standards of the ad delivery system, etc. The list can also be categorized based on market segment (category of business, geography, etc.). This final set of candidate documents 370 may be used by business development employees of the ad delivery system to pursue partner Websites and/or Webpages.

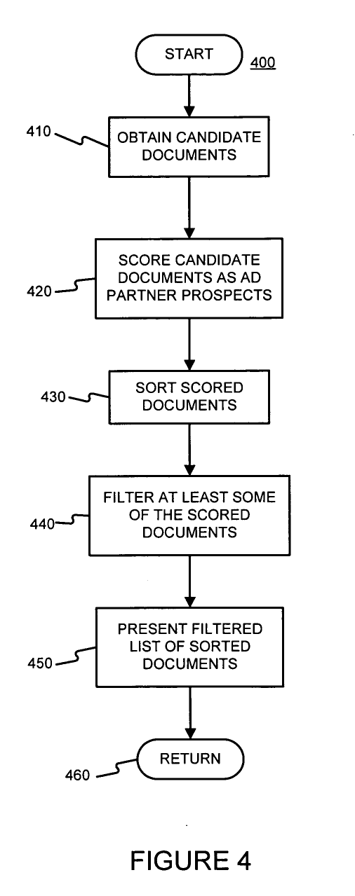

FIG. 4 is a flow diagram of an exemplary method 400 that may be used to perform one embodiment of the present invention. The method 400 can be used to locate content-rich Websites with a lot of user visits for an ad delivery system as mentioned earlier.

Specifically, the method 400 obtains candidate documents. (Block 410) Then, the candidate documents are scored as ad partner prospects. (Block 420) The candidate documents may then be sorted using the scores. (Block 430) At least some of the scored documents may then be subject to filtering. (Block 440) The filtered list of sorted documents may then be presented (Block 450) before the method 400 is left (Node 460).

Referring back to block 410, the method 400 may obtain a set of Webpages by using an existing crawl repository of the ad delivery system. Alternatively, or in addition, a new crawl can be done.

Referring back to block 420, the candidate documents may be scored as ad partner prospects as follows. For each candidate Webpage, the number of page views that the webpage is likely to get, (e.g., over a giver period) is estimated. This estimation might be done using historical data which describes how many times that Webpage (or other Webpages which are related and/or similar) has been visited in the past. Multiple candidate Webpages can be grouped together and their page views may be estimated as a group. The historical data could be obtained in many ways. For example, toolbars that forward Webpage information queries to the ad delivery system when a user views a Webpage could be used. This gives the ad delivery system a sample of how many times that Webpage has been viewed. Nevertheless, other ways of obtaining such information are possible. For example, the ad delivery system could rely upon estimates from third parties with access to similar data, such as click logs showing how many times users have clicked from search results to that Webpage. Alternatively, or in addition, this kind of information can be obtained through a relationship with the Internet Service Provider (ISP) that hosts the Webpage for example.

Although the score of a Webpage may be a function of page views, it can also be a function of an estimate of the economic value of placing ads on the candidate Webpage ($amount/page view). Some possible factors included in this estimation of economic value could be an analysis of the content of the Webpage to identify ads that would be relevant to viewers of the Webpage, and an estimation of the economic value of displaying such relevant ads (e.g., which may, in turn, be a function of estimations of ad selection rates, cost-per-click offers, cost-per-impression offers, etc.). Moreover, the $amount/page view may be a function of potential available ad spots on the Webpage, the topic or topics of the webpage, and information about ads targeted to the topic. Similarly, the economic value can be estimated for a group of multiple candidate Webpages, in addition to, or instead of, for each individual Webpage.

Referring back to block 430, the scored documents may be sorted using the estimated economic values and the estimated page view values. There are at least few different ways of scoring documents. For instance, the documents could be scored by simply using the number of estimated page views as the only criteria. Thus, the list would be prioritized based on the Webpages with the highest number of estimated page views. Alternatively, the documents could be scored by simply using the $amount/page view as the only criteria. In this case, the list would be prioritized based on the Webpages with the highest $amount/page view. As another alternative, the documents could be scored by simply multiplying the estimated economic value per page view by the estimated page views for each page. Hence, the list would be prioritized based on the Webpages with the highest revenue for all estimated page views. Other ways of scoring the documents, and therefore sorting the list, are possible.

Referring back to block 440, the scored and sorted list may contain a wide range of various Webpages, some of which are simply not applicable for advertising or have too low of a ranking. Therefore, the list may be further refined by filtering it. Specifically, the list can be filtered using one or more factors. For example, Webpages that already contain advertising or Webpages that already contain advertising by the current ad delivery system could be filtered out. Webpages which, for some reason, are not good advertising prospects (e.g. Webpages operated by competitor ad delivery systems or the government Webpages that don't accept advertising, etc.), or have been previously identified and discarded, could be filtered out. The list can also be categorized based on market segment (category of business, geography, etc.).

§ 4.2.2 Exemplary Apparatus

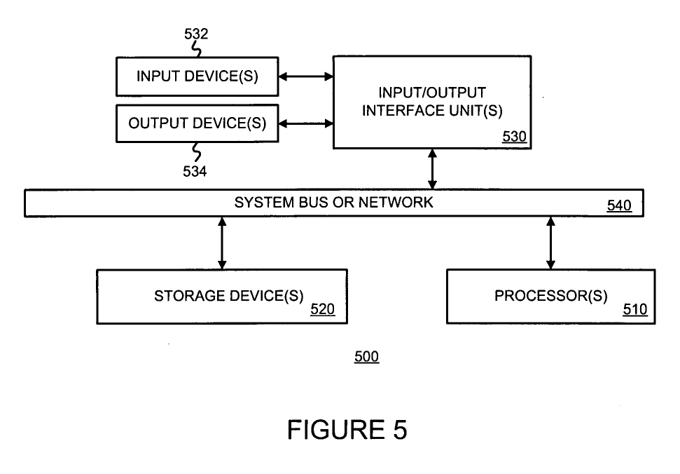

FIG. 5 is high-level block diagram of a machine 500 that may perform one or more of the operations discussed above. The machine 500 basically includes one or more processors 510, one or more input/output interface units 530, one or more storage devices 520, and one or more system buses and/or networks 540 for facilitating the communication of information among the coupled elements. One or more input devices 532 and one or more output devices 534 may be coupled with the one or more input/output interfaces 530.

The one or more processors 510 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 520 and/or may be received from an external source via one or more input interface unit s 530.

In one embodiment, the machine 500 may be one or more conventional personal computers. In this case, the processing units 510 may be one or more microprocessors. The bus 540 may include a system bus. The storage devices 520 may include system memory, such as read only memory (ROM) and/or random access memory (RAM). The storage devices 520 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 532, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 510 through an appropriate interface 530 coupled to the system bus 540. The output devices 534 may include a monitor or other type of display device, which may also be connected to the system bus 540 via an appropriate interface. In addition to (or instead of) the monitor, the personal computer may include other (peripheral) output devices (not shown), such as speakers and printers for example.

Referring back to FIG. 2, one or more machines 500 may be used as ad server 210, search engine 220, content server 230, e-mail server 240, and/or user device 250.

§ 4.2.3 Refinements and Alternatives

The present invention is not limited to the particular embodiments described above. For instance, the present invention could be implemented for use with non-web content, or with documents other than Webpages. The documents could be collected via some mechanism other than a Web crawl. Also the present invention could be implemented for use with collections of documents, rather than with single documents (e.g., for use with Websites rather than Webpages). For example, instead of estimating the number of page views of individual Webpages, the page views of domains can be estimated. Of course, other possibly alternatives and refinements are possible.

§ 4.3 Example of Operations

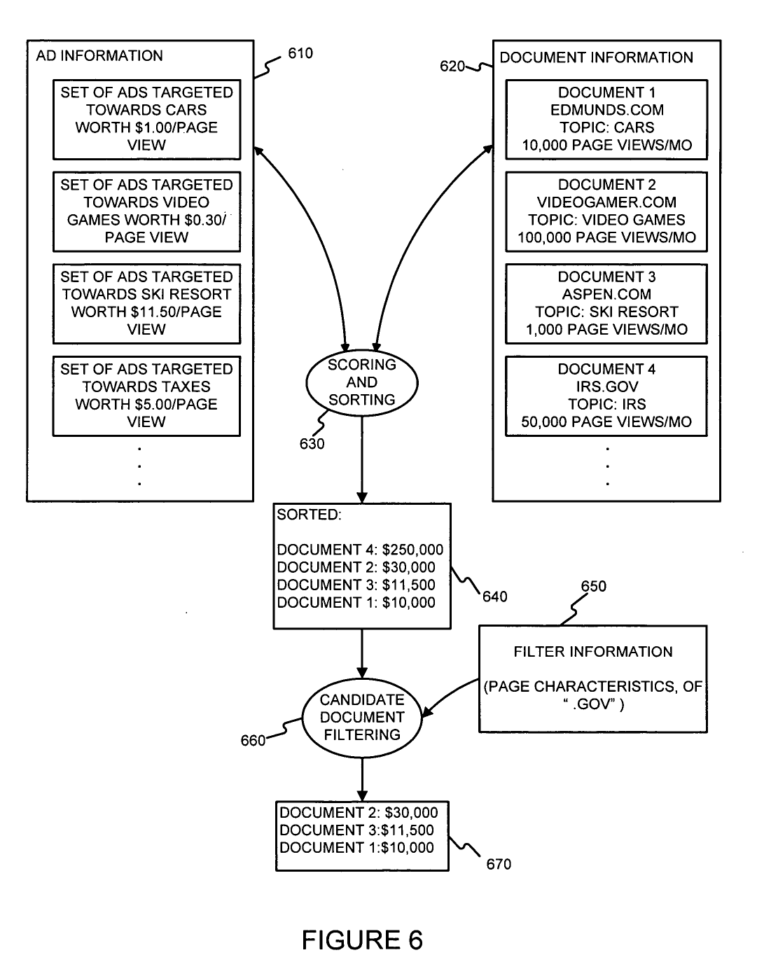

FIG. 6 is a block diagram illustrating an example of operations in an exemplary embodiment of the present invention. In this example, document information 620 (Recall 320 of FIG. 3.) includes crawled Webpages which the ad delivery system obtained from a repository. The document information 620 includes information about a variety of Webpages, such as a topic of the content of the Webpage and the number of page views per month (e.g., as estimated from selections from a search engine search results page). The document information 620 may include other information.

Ad information 610 may include pertinent information about sets of ads. Specifically, the ad information may include the targeted keywords or topics and an estimated cost per impression (e.g., cost per impression, cost per selection times selection rate, cost per conversion times conversion rate, etc.) for a set of ads (e.g., ads relevant to a certain topic).

The scoring operation 630 determines a score for each embodiment. The score may be the product of the number of page views per month and an estimated revenue per page view. Thus, for example, if the Webpage can accommodate N (e.g., 4) ads and concerns topic Y and the top N ads targeted to topic Y have a cumulative estimated cost per impression of $Z, the score for the Webpage will be the product of Z and the estimated number of page views for the Webpage. The resulting score is one way to prioritize the list for prospective ad partners.

According to the document information 620, document 4 is an IRS government Webpage that has IRS and taxes as its topics and receives 50,000 page views per month. The respective set of ads targeted towards Webpages concerning taxes is worth $5.00/page view. Hence, document 4 is given a score of $250,000 per month which is simply the product of the number of page views per month and the number of estimated revenue per page view. Document 2 is a Webpage that has “video games” as its topic and receives 100,000 page views per month. The respective set of ads targeted towards Webpages concerning video games is worth $0.30/page view. Hence, document 2 is given a score of $30,000 per month. Document 3 is a Webpage that has “ski resort” as its topic and receives 1,000 page views per month. The respective set of ads targeted towards Webpages concerning ski resorts is worth $11.50/page view. As a result, document 3 is given a score of $11,500 per month. Finally, document 1 is a Webpage that has “cars” as its topic and receives 10,000 page views per month. The respective set of ads targeted towards Webpages concerning cars is worth $1.00/page view. Therefore, document 1 is given a score of $10,000 per month.

The scoring and sorting operation 630 sorts the documents using their scores. The documents are sorted, from highest score to lowest score, as shown by list 640. Thus, document 4 has the highest position, followed by document 2 in the second position, document 3 in the 3^{rd} position and document 1 in the 4^{th} position.

Subsequently, the scored and sorted list 640 of candidate documents is provided to filtering operations 660 which remove those documents considered to be inappropriate prospective ad partners. Filtering operations 660 use filter information 650 to filter the documents. Filter information 650 may contain Webpage characteristics, such as whether the webpage is from a competitor's ad delivery system, is a government Webpage, etc. Therefore, the list can be filtered using one or more factors, such as whether the Website is of a competitor's ad delivery system which will not display the ads, or if it is a government Website or other Websites that do not place ads by any means. In the illustrated example, the filter information includes filtering out Webpages with a “.gov” extension. Thus, document 4 would be removed by filtering operations 660 because the Webpage has a “.gov” extension. Additional factors for filtering the candidate list of documents can be applied by simply adding them to the filter information 650. Since documents 1, 2, and 3 are found to be eligible prospective ad partners, they are passed through.

The filtered and sorted list 670 is then presented as a list of good prospective ad partners.

### § 4.4 CONCLUSIONS

As can be appreciated from the foregoing disclosure, the embodiments consistent with the present invention can be used to locate and identify good prospective advertising partners, while avoiding a slow and often subjective manual approach of searching and browsing the Web. Using available data such as crawled Webpages, access statistics, Webpages which represent good prospect for being advertising hosts can be found. Manual labor, cost and time can be saved. The best prospects in terms of potential revenue can be found.

This helps the ad delivery system to locate prospective Webpages and/or Websites to pursue advertising partners efficiently and economically. Furthermore, this will help the ad delivery system to reduce having personnel look for prospective partner Websites manually, often without the benefit of economic data.

What is claimed is:

1. A computer-implemented method comprising:
a) accepting documents;
b) scoring the documents to provide a score for each of the documents;
c) sorting the scored documents using the scores; and
d) filtering the documents to remove documents that are not likely to be good prospective advertising partners.

2. The computer-implemented method of claim 1 further comprising:
e) after filtering and scoring the documents, presenting the documents as prospective advertising partners.

3. The computer-implemented method of claim 1 wherein the act of scoring the documents scores each document using an estimated number of impressions of the document over a time period.

4. The computer-implemented method of claim 1 wherein the act of scoring the documents scores each document using ad information.

5. The computer-implemented method of claim 4 wherein the ad information includes information targeting one or more ads to the document.

6. The computer-implemented method of claim 4 wherein the ad information includes offer information of one or more ads targeted to the document.

7. The computer-implemented method of claim 1 wherein the act of filtering includes removing documents belonging to a predetermined set of documents.

8. The computer-implemented method of claim 1 wherein the documents are Webpages, and wherein the act of filtering includes removing Webpages belonging to a predetermined set of Webpages.

9. The computer-implemented method of claim 8 wherein the predetermined set of Webpages is a Website.

10. The computer-implemented method of claim 1 wherein the documents are Webpages, and wherein the act of filtering includes removing government Webpages.

11. The computer-implemented method of claim 1 wherein the act of filtering documents includes removing documents known to have a policy of excluding advertisements.

12. A computer-implemented method comprising:
a) accepting documents;
b) scoring the documents to provide a score for each of the documents, wherein the act of scoring the documents scores each document using ad information; and
c) sorting the scored documents using the scores.

13. The computer-implemented method of claim 12 further comprising:
d) presenting the sorted documents as prospective advertising partners.

14. The computer-implemented method of claim 12 wherein the act of scoring the documents scores each document using an estimated number of impressions of the document over a time period.

15. The computer-implemented method of claim 12 wherein the ad information includes information targeting one or more ads to the document.

16. The computer-implemented method of claim 12 wherein the ad information includes offer information of one or more ads targeted to the document.

17. The computer-implemented method of claim 12 wherein the score for each document is determined using an estimated advertising revenue of serving a set of one or more ads with an impression of the document.

18. The computer-implemented method of claim 17 wherein the score further includes an estimated number of impressions of the document over a given time period.

19. The computer-implemented method of claim 12 wherein the score for each document includes a product of (i) an estimated advertising revenue of serving a set of one or more ads with an impression of the document and (ii) an estimated number of impressions of the document over a given time period.

20. Apparatus comprising:
a) means for accepting documents;
b) means for scoring the documents to provide a score for each of the documents;
c) means for sorting the scored documents using the scores; and
d) means for filtering the documents to remove documents that are not likely to be good prospective advertising partners.

21. Apparatus comprising:
a) means for accepting documents;
b) means for scoring the documents to provide a score for each of the documents, wherein the act of scoring the documents scores each document using ad information; and
c) means for sorting the scored documents using the scores.
